(19) United States
(12) Patent Application Publication
(10) Pub. No.: US 2012/0256357 A1
(43) Pub. Date: Oct. 11, 2012

(54) USE OF COANDA EFFECT DEVICES TO PRODUCE MELTBLOWN WEBS WITH IMPROVED SIDE-TO-SIDE UNIFORMITY

(75) Inventors: William P. Klinzing, West Lakeland, MN (US); Andrew W. Chen, Woodbury, MN (US); James C. Breister, Oakdale, MN (US); Patrick J. Sager, Hastings, MN (US)

(73) Assignee: 3M Innovative Properties Company

(21) Appl. No.: 13/441,338

(22) Filed: Apr. 6, 2012

Related U.S. Application Data
(60) Provisional application No. 61/472,395, filed on Apr. 6, 2011.

(51) Int. Cl. B29C 47/00

(52) U.S. Cl. 264/555; 425/72.2

(57) ABSTRACT

An apparatus for producing meltblown webs includes a meltblowing die having a plurality of filament outlets, a collector for receiving filaments of polymeric material expelled from the filament outlets, and a first Coanda effect device positioned adjacent to the path of the filaments adjacent to the last filament outlet at an end of the meltblowing die. Methods of forming meltblown webs using such an apparatus are also disclosed.

### CROSS-REFERENCE TO RELATED APPLICATION

This application claims priority to U.S. Provisional Patent Application No. 61/472395, filed Apr. 6, 2011, the disclosure of which is incorporated by reference herein in its entirety.

### BACKGROUND

The present disclosure relates generally to making webs of nonwoven media, and, more particularly, to a method and apparatus for making such webs of nonwoven media.

In recent years, meltblown media has come into wide commercial use, for uses such as filtration, cleaning wipes, bandages, surgical drapes, battery electrode separation and insulation.

### SUMMARY

For many applications, it is desirable that webs of nonwoven media have a uniform basis weight. For example, when a web of nonwoven media has been converted into an air filter, thin spots may provide places where airborne contaminants could bypass the filter. With known melt blowing equipment and methods, it is difficult to maintain uniformity at the edges of the forming media. Thus, for applications requiring a high degree of uniformity, the edges of the media must be trimmed away and discarded as waste. In addition, a meltblowing die of a particular width will provide useful media of a lesser width at the collector. This is especially noticeable when the collector is positioned more than 40 cm from the meltblowing die. For example, a 200 cm wide die may produce usable webs having a width of only 175 cm.

The need exists for a method and apparatus for forming meltblown webs with better side-to-side uniformity, and/or that can produce webs having a width equal to or greater than the width of the die.

The present disclosure generally provides a method and apparatus for forming a meltblown web by positioning a Coanda effect device adjacent to the flight path of the fibers emerging from the blowing die on at least one edge of the web. While not wishing to be bound by any theory, it is believed that the Coanda effect provided by the Coanda effect device redirects some of the fibers which would otherwise form an insufficiently thick “ragged edge” on the web formed on the collector.

In one embodiment, the present disclosure provides a meltblowing apparatus, comprising a meltblowing die having a plurality of filament outlets, a collector for receiving filaments of polymeric material expelled from the filament outlets, and a first Coanda effect device positioned adjacent to the path of the filaments adjacent to the last filament outlet at an end of the meltblowing die.

In another embodiment, the present disclosure provides a method of forming a meltblown media, comprising providing a meltblowing die having a plurality of filament outlets, positioning a first Coanda effect device adjacent to a first end of the meltblowing die, expelling molten filaments from a meltblowing die, manipulating the flight of the molten filaments with the first Coanda effect device, and collecting the molten filaments to form a web of nonwoven media.

One advantage of webs formed using the apparatus and method of the present disclosure is that they have more uniform side-to-side basis weights compared to webs made according to conventional techniques. That is, the basis weight of the side edge regions of webs produced using the apparatus and methods described herein are similar to, and consistent with, the basis weight of the central region of the web located between the side edge regions.

As used herein, forms of the words “comprise”, “have”, and “include” are legally equivalent and open-ended. Therefore, additional non-recited elements, functions, steps or limitations may be present in addition to the recited elements, functions, steps, or limitations.

### BRIEF DESCRIPTION OF THE DRAWINGS

It is to be understood by one of ordinary skill in the art that the present discussion is a description of exemplary embodiments only, and is not intended as limiting the broader aspects of the present disclosure, which broader aspects are embodied in the exemplary construction.

FIG. 1 is a schematic view of a meltblowing apparatus without the inventive features.

FIG. 2 is a perspective view of one end of a meltblowing die generally as depicted in FIG. 1, except that certain inventive features have been added.

FIG. 3 is a perspective view of a Coanda effect device according to the invention in isolation.

FIG. 4 is a plan view of the Coanda effect device of FIG. 3.

Repeated use of reference characters in the specification and drawings is intended to represent the same or analogous features or elements of the disclosure.

### DETAILED DESCRIPTION

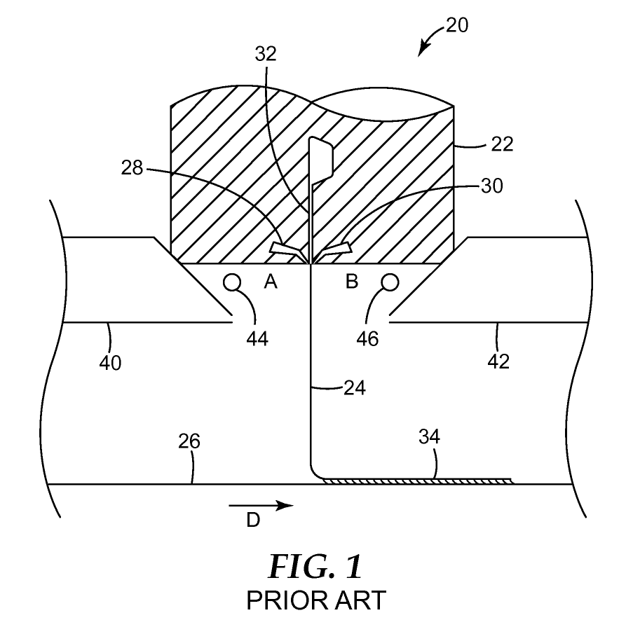

Referring now to FIG. 1 a schematic view of a meltblowing apparatus 20 is illustrated without the inventive features for background and the establishment of nomenclature. A meltblowing apparatus 20 including a meltblowing die 22 is illustrated in a diagrammatic cross-section. The meltblowing die 22 is used to expel a stream 24 of extended polymeric filaments towards a collection belt 26 moving in direction “D,” is illustrated. Although a belt is depicted in connection with this embodiment, those acquainted with the meltblowing art will understand that other collectors, such as a rotating drum, may be used for the purpose of collecting, conveying, and taking off the filaments as media.

According to conventional practice, the meltblowing die 22 is provided with cavities 28 and 30 for directing two streams of heated gas against the stream 24 of polymeric filaments just after the stream 24 has been extruded from a line of extrusion orifices 32. The heated gas jets emerging from cavities 28 and 30 extend and thin the filaments emerging from the extrusion orifices 32 so that the filaments have the proper size and dispersion to form the desired media 34 upon the collector 26.

The meltblowing apparatus 20 further includes a pair of ducts 40 and 42, one upstream and one downstream of the stream 24 compared to the direction “D”. Secondary flow is expelled from ducts 40 and 42 against the filament stream 24 so the filaments, when they impinge upon the collection belt 26, have the properties desired in the media 34. The foregoing description generally corresponds to the disclosure of coassigned U.S. Pat. No. 6,861,025 to Breister et al, and is adequate for the production of meltblown media at low and moderate speeds of collector 26. As discussed in copending and coassigned U.S. Application Publication 20060265169, additional manifolds 44 and 46 may be provided for the purpose of disrupting standing vortices.

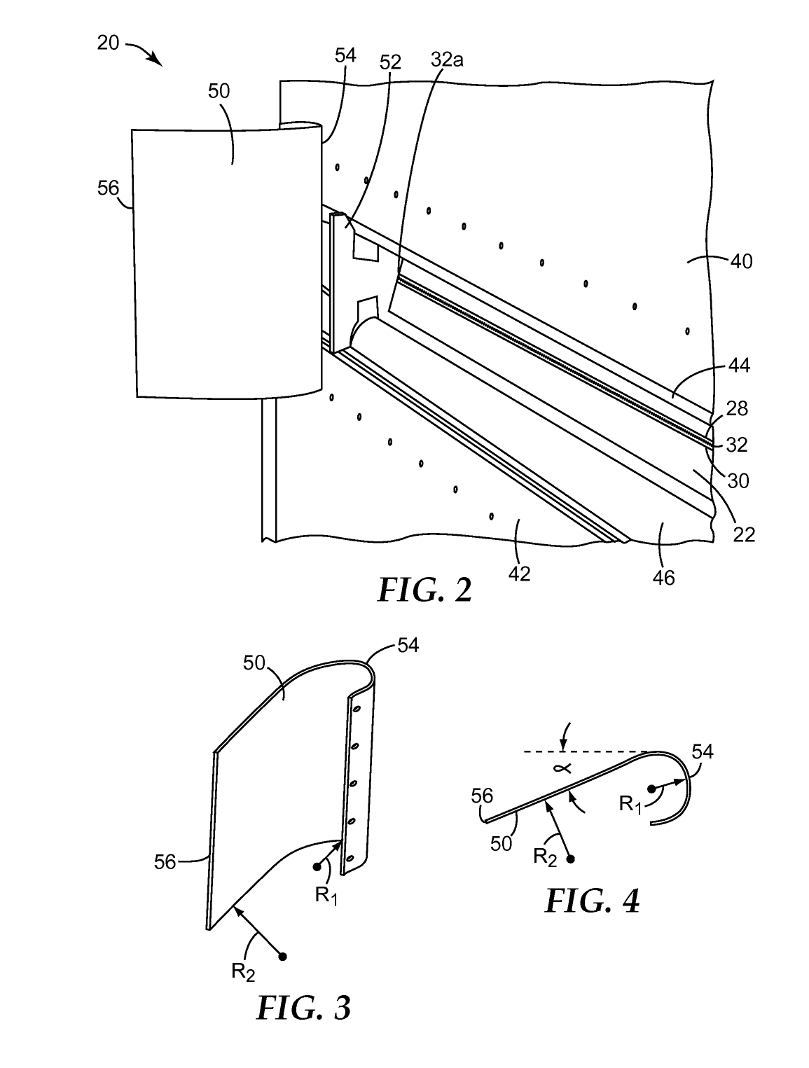

Referring now to FIG. 2, a perspective view of one end of the meltblowing die 22 including certain inventive features is illustrated. Specifically, a first Coanda effect device 50 is positioned adjacent to the path of the filaments emerging from the last orifice 32a at an end of the meltblowing die 22. The Coanda effect device 50 generally comprises a convex surface arranged along the direction of the filament flow path. In the illustrated embodiment, the convex surface flares outwardly away from the array of orifices 32 in the direction away from the meltblowing die 22. Arranged in this manner, the convex surface serves to alter, or can be used to adjust or control, the flow path of the filaments in the region adjacent to the Coanda effect device 50, thereby producing a web of media having a more consistent and uniform basis weight across its entire width.

A shield 52 is positioned between the lateral end of the array of orifices 32 and the first Coanda effect device 50. The shield 52 is positioned to direct and regulate the entrainment of ambient air from the side of the die 22 towards the leading edge 54 of the first Coanda effect device 50. It will be recognized that a second Coanda effect device and a second shield may optionally be provided at the other end of the array of orifices 32.

Referring now to FIGS. 3 and 4, there is shown a perspective view and a plan view, respectively, of a Coanda effect device 50 shown in isolation. The Coanda effect device 50 has a leading edge 54 and a trailing edge 56. The exact parameters of an advantageous Coanda effect device will vary depending on the material being extruded from the orifices 32 and other process parameters. However, some general observations for achieving desirable results have been made.

According to one aspect, the Coanda effect device may be characterized in terms of a first radius of curvature “R1” adjacent to the leading edge 54, a second radius of curvature “R2” adjacent to the trailing edge 56, and/or an angle of attack α. The angle of attack α can be defined generally as the angle between the surface of the Coanda effect device and a line generally parallel to the streamlines of material 24 emerging from the orifices 32.

For most applications, the first R1 and second R2 radii of curvature and the angle of attack α should be selected so as to minimize vortex shedding at the trailing edge 56. In specific embodiments, the angle of attack α may be less than about 45 degrees, less than about 35 degrees, or less than 25 degrees. Negative angles of attack are less commonly indicated, but not considered to be outside the scope of the invention. In specific embodiments, the first radius of curvature R1 may be at least about 4 cm, at least about 6 cm or at least about 7.5, and no greater than about 24 cm, no greater than about 20 cm, or no greater than about 18 cm. In another embodiment, the second radius of curvature R2 may be at least about 14 cm, at least about 16 cm, or at least about 18 cm. It is to be noted that the approximation of the Coanda effect device into two radii of curvatures R1 and R2 is guidance as to operable embodiments. Cross sectional shapes corresponding to diverse geometries including, for example, spline curves, facets, or combinations of the two, are considered to be within the scope of the invention.

For simplicity of manufacture, it may be desirable for the Coanda effect device to have a uniform cross section, but this is not considered essential. Also, in embodiments where two Coanda effect devices are provided, it may be desirable that the first and second Coanda effect devices be similar or even identical, but this is not considered essential. The Coanda effect devices may optionally include mechanical expedients such as cams, levers, bolts or the like so that minor adjustments to the radii of curvature and/or angle of attack can be made to the Coanda effect device during, for example, the production of meltblown media.

Other modifications and variations to the present disclosure may be practiced by those of ordinary skill in the art, without departing from the spirit and scope of the present disclosure, which is more particularly set forth in the appended claims. It is understood that aspects of the various embodiments may be interchanged in whole or part or combined with other aspects of the various embodiments. All cited references, patents, or patent applications in the above application for letters patent are herein incorporated by reference in their entirety in a consistent manner. In the event of inconsistencies or contradictions between portions of the incorporated references and this application, the information in the preceding description shall control. The preceding description, given in order to enable one of ordinary skill in the art to practice the claimed disclosure, is not to be construed as limiting the scope of the disclosure, which is defined by the claims and all equivalents thereto.

What is claimed is:

1. A meltblowing apparatus, comprising:
a meltblowing die having a plurality of filament outlets,
a collector for receiving filaments of polymeric material expelled from the filament outlets, and
a first Coanda effect device positioned adjacent to the path of the filaments adjacent to the last filament outlet at an end of the meltblowing die.

2. A meltblowing apparatus according to claim 1 further comprising a second Coanda effect device positioned adjacent to the path of the filaments adjacent an opposite end of the meltblowing die.

3. A meltblowing apparatus according to claim 1 further comprising a first shield positioned between the first end of the meltblowing die and the first Coanda effect device.

4. A meltblowing apparatus according to claim 1 wherein the distance between the filament outlets and the collector is at least about 40 cm.

5. A meltblowing apparatus according to claim 1 wherein the Coanda effect device has a trailing edge, and wherein the angle of attack of the Coanda effect device is selected so as to minimize vortex shedding at the trailing edge.

6. A meltblowing apparatus according to claim 5 wherein the angle of attack of the Coanda effect device is no more than about 45 degrees.

7. A meltblowing apparatus according to claim 6 wherein the Coanda effect device has a minimum radius of curvature R2 adjacent to the trailing edge, and wherein R2 is at least about 18 cm.

8. A meltblowing apparatus according to claim 3 wherein the first shield is positioned to direct the flow of entrained air towards the first Coanda effect device.

9. A meltblowing apparatus according to claim 7, wherein the radius of curvature R2 is adjustable.

10. A method of forming a meltblown media, comprising:
providing a meltblowing die having a plurality of filament outlets,
positioning a first Coanda effect device adjacent to a first end of the meltblowing die,
expelling molten filaments from a meltblowing die,
manipulating the flight of the molten filaments with the first Coanda effect device, and
collecting the molten filaments to form a web of nonwoven fibrous media.

11. A method according to claim 10 further comprising positioning a second Coanda effect device adjacent to a second end of the meltblowing die opposite the first end.

12. A method according to claim 10 further comprising positioning a shield between the first end of the meltblowing die and the first Coanda effect device.

13. A method according to claim 10 wherein the collecting is accomplished on a collector, and wherein the distance between the filament outlets and the collector is at least about 40 cm.

14. A method according to claim 10 wherein the Coanda effect device has a trailing edge, and wherein the angle of attack of the Coanda effect device is selected so as to minimize vortex shedding at the trailing edge.

15. A method according to claim 14 wherein the angle of attack of the first Coanda effect device is no more than about 45 degrees.

16. A method according to claim 14 wherein the Coanda effect device has a minimum radius of curvature R2 adjacent to the trailing edge, and wherein R2 is at least about 18 cm.

17. A method according to claim 12 wherein the shield is positioned to direct the flow of entrained air towards the first Coanda effect device.
